(19) United States
(12) Patent Application Publication
(10) Pub. No.: US 2005/0162312 A1
(43) Pub. Date: Jul. 28, 2005

(54) Method and device for processing raw GPS data

(75) Inventor: Ossian Riday, Topsham, ME (US)

Correspondence Address: BOHAN, MATHERS & ASSOCIATES, LLC, PO BOX 17707, PORTLAND, ME, 04112-8707, US

(73) Assignee: DeLorme Publishing Co., Yarmouth, ME (US)

(21) Appl. No.: 11/046,094

(22) Filed: Jan. 28, 2005

Related U.S. Application Data
(60) Provisional application No. 60/539,749, filed on Jan. 28, 2004.

(51) Int. Cl. G01S 5/14

(52) U.S. Cl. 342/357.13

(57) ABSTRACT

Method and device for processing raw GPS data to obtain extremely accurate corrected navigation data. The device is a stand-alone, puck-like GPS receiver/data logger that records raw data according to pre-programmed instructions. Ephemeris data and/or ionosphere prediction data that provide high accuracy for the time and location of data logging are uploaded into data processing software for processing the raw GPS data received via satellite signal. The raw GPS data may be post-processed on an external computing device or processed in realtime in the GPS receiver/data logger. The corrected navigation data thus obtained provides navigation data with submeter accuracy.

### BACKGROUND INFORMATION

1. Field of the Invention

This invention relates to the field of Global Positioning Systems (GPS). More particularly, the invention relates to an integrated GPS receiver/data logger device. More particularly yet, the invention relates to a method of obtaining highly accurate navigation data from logged raw GPS data.

2. Description of the Prior Art

GPS receivers are well known devices for determining the location or position coordinates of objects, tracking the travel of a vehicle, and for mapping applications. A well-known use of a GPS receiver, for example, is to provide location data to a computerized road map or atlas system, in order to obtain guidance or directions to reach a certain destination. Vehicle fleets often employ GPS receivers to track the whereabouts of each vehicle. In this case, a GPS receiver is installed in each vehicle and the data obtained from the GPS receiver is transmitted to a computerized central tracking station. Generally, the data is transmitted via radio broadcast.

The currently available GPS receivers and data systems have several disadvantages, the primary disadvantage being that the raw data obtained from the GPS receiver does not provide the desired accuracy. The inaccuracy is generally due to error in ranging, i.e., determining the precise location of the satellites that broadcast the GPS data. In years past, the Department of Defense intentionally induced errors in range and range rate calculations by dithering the clock signal that controls the carrier frequency and the code broadcast by the NAVSTAR GPS satellites. This dithering, referred to as Selective Availability (SA), has since been removed, but even now, the obtainable accuracy of a GPS receiver is generally about 20 meters and, at best, about 5 meters. This lack of accuracy is due to other sources of error in ranging, such as ephemeris error and ionospheric disturbances. In order to obtain accuracy to one meter or less, the raw data obtained from the GPS satellites must be processed to compensate for errors resulting from the ephemeris and ionospheric activity.

Over the years, GPS navigation systems that provide greater accuracy have been developed. One such system, a Differential GPS (DGPS), is disclosed in U.S. Pat. No. 6,324,473 (Eschenbach; 2001). A GPS reference or base station is placed at a particular location, where the position coordinates of the location have been determined with high accuracy by means other than the data from GPS satellites. In a DGPS, one or more user or roving GPS receivers are used that are also in contact with the reference station via radio broadcast. Because the position coordinates of the reference station are known, it is possible to calculate differential pseudorange values (correction data) for the satellite-broadcast GPS data received at the reference station. Because the error in the satellite-transmitted GPS data is common to all GPS receivers that are in relative close geographic proximity to the GPS station, the correction data can also be used to correct the GPS data received by the rover GPS receivers. In order to obtain corrected GPS navigation or position data in real-time, the correction data is broadcast to the GPS receivers via radio frequency. It is possible to post-process the data from the GPS receivers to correct the timing errors and errors resulting from ionospheric activity, but the known post-processing techniques, which include single-difference, double-difference, and triple-difference pseudorange processing, also rely on a DGPS system and calculate differential GPS values, based on the evaluation of data simultaneously collected from a roving GPS receiver and a reference station.

The DGPS method of obtaining accurate position data has several disadvantages. For one, it requires that the GPS receivers receiving the data corrections be in relatively close proximity geographically to the reference station. For another, it requires that the GPS receivers be in radio contact with the reference station. This adds to the cost of collecting accurate data. Furthermore, GPS reference stations that provide the desired accuracy are generally very expensive. Many applications for GPS receivers today require that the GPS receiver be inexpensive in acquisition and operation, very portable, and unrestricted geographically to a reference station.

Currently, some GPS receivers support the Wide Area Augmentation System (WMS) being developed by the Federal Aviation Administration and the Department of Transportation. WAAS corrects some of the errors of the GPS signal resulting from ionospheric disturbances, timing, and satellite orbit errors. In addition, WMS provides integrity information relating to each GPS satellite. GPS receivers that support WMS are capable of delivering position information with an accuracy resolution of approximately seven meters. Although this resolution may be adequate for many professional applications, WMS signals cannot always be obtained, thereby reducing the reliability of the system. For example, the WAAS satellites are positioned at the equator and in order to obtain a view of a WAAS satellite, the user needs a clear unobstructed view of the southern sky. Trees or other object in the line of sight obstruct signal reception. Also, WAAS is available only on the North and South American continents. Other countries or regions are developing similar systems (EGNOS in Europe; MSAS in Japan), but these systems will suffer from the same weaknesses as WAAS.

The current methods of using a GPS receiver to obtain position data with a high accuracy, for example, in the sub-meter range, rely on systems in which the GPS receiver receives a continuous external signal that corrects the errors in the satellite broadcast data in real-time, or in which data collected from one or more GPS receivers is post-processed with data collected simutaneously from a reference station. The necessity of having a reference station that provides accurate navigation or position data greatly increases the cost of GPS systems. Reliance on an external signal inherently has disadvantages in that it increases the power required to operate the GPS receiver, and, as the external signal is typically a broadcast signal, it also requires close proximity or an unobstructed “view” between the receiver and the reference station.

What is needed, therefore, is a small, inexpensive, device that provides navigation or position data having sub-meter accuracy, without requiring the input of an external signal. What is further needed is such a device that logs raw data for post-processing at a later time. What is yet further needed is a method of post-processing raw GPS data to obtain navigation or position data with sub-meter accuracy. What is still yet further needed is a method of real-time processing of raw data to obtain navigation or position data having sub-meter accuracy.

### BRIEF SUMMARY OF THE INVENTION

For the reasons cited above, it is an object of the present invention to provide a small, inexpensive, stand-alone device that logs raw GPS data and does not require the input of an external signal. It is a further object to provide a method of post-processing the raw data to obtain navigation data that has sub-meter accuracy. It is a yet further object to provide a method of real-time processing of logged raw GPS data to obtain data with sub-meter accuracy, in real-time, without requiring a wireless or other connection to a GPS reference station during data processing.

The objects are achieved by providing a GPS receiver/data logger, that is a small, stand-alone, puck-like device that logs raw GPS data, and a method of obtaining navigation data with sub-meter accuracy from the GPS receiver/data logger according to the invention. The GPS receiver/data logger according to the invention logs raw data, as well as the conventional navigation data. The raw data includes the L1-frequency pseudo-random noise (PRN) and carrier phase signals broadcast from GPS satellites. Depending on the particular software application used with the GPS receiver/data logger, satellite-broadcast ephemeris data may also be logged.

The GPS receiver/data logger comprises a conventional GPS baseband/radio frequency (RF) chip, an antenna, a memory, an external-device interface, and a power circuit. The power circuit is connected to a charging circuit, an internal battery, and an ON/OFF switch. The components of the GPS receiver/data logger are conventional commercially available components: the GPS chip is available from SIRF, the memory is an AMD flash memory, the antenna an internal ceramic patch antenna, the battery a rechargeable Lithium-ion battery, and the external-device interface is a Bluetooth, USB, or RS-232 interface. For ease of use and convenience, the external-device interface is a bluetooth wireless interface, that enables connection of the GPS receiver/data logger with an external computing device, such as a desktop computer or PDA. The GPS receiver/data logger lacks a display and control buttons, other than the ON/OFF switch, which switches the GPS receiver/data logger off completely, rather than putting it into sleep mode.

Instructions for logging raw GPS data, and also broadcast navigation or position data are stored in the memory. Navigation data includes longitude, latitude, elevation, heading, and velocity of a body, whereas position data includes only the longitude, latitude, and elevation of the body. The term “navigation data” will be used hereinafter, although it shall be understood that, depending on the application, heading and/or velocity may not be included. Navigation data that has been processed to obtain more accurate data than the satellite-broadcast navigation data shall be referred to hereinafter as “corrected navigation data.” The GPS receiver/data logger according to the invention records or logs raw GPS data for a certain period of time. The GPS receiver/data logger may be set up at a stationary location, or may be carried in a vehicle to log data for the distance traveled on a trip or in a day. The raw GPS data is processed to obtain the corrected navigation data, which may then be used together with commercially available mapping or atlas software. The raw GPS data, according to the methods of the invention, may be post-processed or processed in real-time.

One typical use of the GPS receiver/data logger according to the invention is to obtain corrected navigation data for a distance traveled. A user on a bike trip, for example, may want to have corrected navigation data for the entire trip. A tracking system for a fleet of vehicles, on the other hand, may want corrected navigation data from a delivery vehicle at the end of each delivery day or in real-time.

The method according to the invention processes the raw GPS data to obtain corrected navigation data with a high resolution, ideally in the sub-meter range, without relying on an external signal. Inaccurate broadcast ephemeris data and clock errors in broadcast data due to ionospheric activity are the two major sources of error in GPS broadcast data. Rapid predicted ephemeris tables are available for download from the Internet, as are ionosphere prediction tables. These tables provide data with a predicted accuracy for a certain period of time. For example, the ephemeris tables are considered to be sufficiently accurate for up to 12 hours for processing the broadcast data to obtain navigation data with an accuracy in the sub-meter range; the ionosphere prediction tables are provided on a daily basis.

Software, such as the commercially available GPS PostPro™, Version 2.0, provided by DeLorme Publishing Co. of Yarmouth, Maine, calculates GPS error correction data, based on the more accurate ephemeris tables and the ionosphere prediction tables that are available on the Internet. Ephemeris and ionosphere tables are made available by various agencies on the Internet and provide accurate data for the specific times when the raw GPS data was collected. For example: predicted ephemeris data tables are provided by the International GPS Service (IGS) and other agencies, and modeled ionosphere data are provided by the Center for Orbit Determination in Europe (CODE). The raw GPS data is processed with the error correction data to obtain corrected navigation data, which may then be processed by application software, such as the DeLorme Street Atlas®, for example, to provide accurate information on the precise route that was covered on the bike trip or by the delivery vehicle.

A first example of applying the method according to the invention to obtain sub-meter corrected navigation data with the GPS receiver/data logger will describe the method of post-processing the raw GPS data, using the example of logging the travel of a delivery vehicle, such as is desirable when tracking a vehicle in a fleet of vehicles. The GPS receiver/data logger is placed in the delivery vehicle. The data logger logs data throughout the day or the delivery route. At the end of the day or the delivery route, the logged raw data is downloaded to a computing device that contains raw-data processing software, such as the DeLorme GPS PostPro™, and is post-processed with the software to obtain the desired corrected navigation data, which has an accuracy that is at or below one meter.

Just as with logging navigation data, various filters may be also used to control the logging of raw data, to increase the efficiency and use of memory in the logger. One example of a useful filter for initiating or halting logging is the speed of the vehicle. The GPS receiver/data logger is programmable to log data only when the vehicle is moving, or only when the vehicle is traveling above or below a certain threshold speed, etc.

The uses of the GPS receiver/data logger described above are typical for vehicle tracking. The GPS receiver/data logger and the method according to the invention are also quite suitable for collecting data for mapping applications. In such applications, the GPS receiver/data logger is used in a single-click operation to record raw GPS data from a series of points from a geographic area. The GPS receiver/data logger is set at a first location and turned on. The GPS receiver/data logger records data and shuts off automatically after a pre-programmed period of time. The accuracy of the data increases with the amount of time the data logger logs at one location and, thus, the GPS receiver/data logger should ideally be allowed to log data at a single location for several minutes, and, preferably, for 20 minutes. The user then moves the GPS receiver/data logger to a new location, clicks it on and lets it record data for the pre-programmed period of time. In this manner, the user may record data from a series of locations that encompass the geographic area. The raw GPS data is post-processed, in the manner described above, to obtain accurate terrain data that is then registrable on a map of given coordinates.

The GPS receiver/data logger according to the invention is a simple device, without display and controls, other than an ON/OFF switch, and, thus, is inexpensive. The cost of acquiring multiple such devices is much less than acquiring a conventional GPS system that provides corrected navigation data with sub-meter accuracy. It is particularly useful and cost-effective to acquire multiple GPS receiver/data loggers for use in mapping. The user may then set up multiple GPS receiver/data loggers at multiple locations around the perimeter of an area to be mapped, thereby eliminating wait time while simultaneously obtaining multiple recordings that are then used to obtain a precise map of the area. Obtaining multiple recordings from various locations in geographically close proximity has the added advantage in that the data points thus obtained may be used to further increase the accuracy of the corrected navigation data.

The raw GPS data may also be processed in real-time with the method according to the invention. In this case, the more accurate ephemeris tables and ionosphere prediction tables that are available on the Internet are uploaded to the GPS receiver/data logger at the beginning of the workday or work session and stored in the flash memory in the logger. The software for processing the raw data is also stored in the flash memory. The raw GPS data is then processed by the software as it is received, providing in real-time corrected navigation data with the desired sub-meter accuracy.

### BRIEF DESCRIPTION OF THE DRAWINGS

The present invention is described with reference to the accompanying drawings. In the drawings, like reference numbers indicate identical or functionally similar elements.

FIG. 1 is a perspective view of the GPS receiver/data logger according to the invention.

FIG. 2 is a block diagram of the GPS receiver/data logger according to the invention.

FIG. 3 is a flow chart of a method of post-processing the logged raw data to obtain corrected navigation data.

FIG. 4 is a flow chart of a method of real-time processing of the logged raw data to obtain corrected navigation data.

### DETAILED DESCRIPTION OF THE INVENTION

FIG. 1 illustrates a GPS receiver/data logger 100 according to the invention. The GPS receiver/data logger 100 comprises a housing 101, an ON/OFF switch 103, an ON/OFF indicator light 104, a status indicator light 105, and an external connector 106 for connecting the GPS receiver/data logger 100 to an external power source. An external antenna connector 107 is also provided, to enable the user to connect the GPS receiver/data logger 100 to an external antenna. The preferred embodiment of the GPS receiver/data logger 100 is a wireless device and, therefore, requires no external connector for connecting the device to a computing device. It is within the scope of the invention, however, to optionally provide the GPS receiver/data logger 100 with an external connector 108 for connecting it to an external computing device via a USB and/or a RS-232 cable.

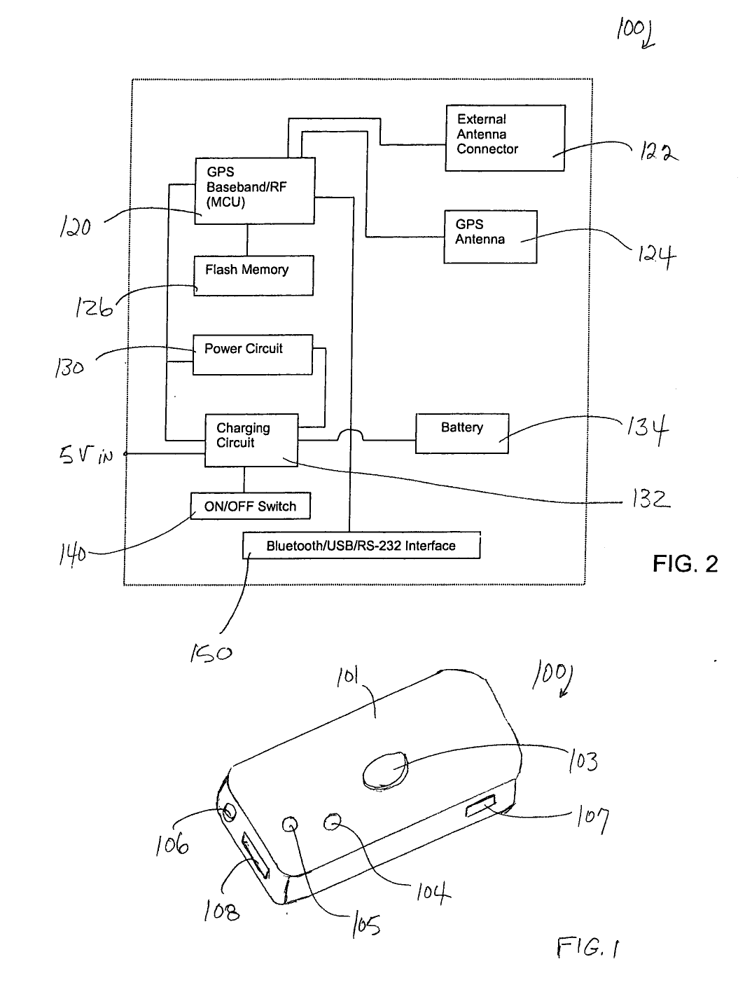

FIG. 2 is a block diagram that illustrates the functional elements of the GPS receiver/data logger 100. A conventional GPS baseband/radio frequency (RF) chip 120 is connected to an internal GPS antenna 124 and to an external antenna connector 122. The GPS chip 120 is also connected to a flash memory 126, an external-device interface 150, and a power circuit 130. The power circuit 130 is connected to a charging circuit 132, an internal battery 134, and an ON/OFF switch 140. The GPS chip 120 is a conventional GPS chip, such as one available from SIRF. Other components of the circuitry are also conventional components that are commercially available, such as an AMD flash memory, an internal ceramic patch antenna, a rechargeable Lithium-ion battery, and a Bluetooth, USB, or RS-232 interface. It is understood that each of these components influences the accuracy of the GPS receiver/data logger, and that the degree of accuracy of the navigation data obtained with the GPS receiver/data logger 100 may vary, depending on the accuracy of the individual components.

Instructions for logging raw data are stored in the flash memory 126, as are the logged raw data. The battery 134 is rechargeable by connecting the GPS receiver/data logger 100 via the external connector 106 to a suitable power source. The charging circuit 132 recognizes when power is available at the external connector 106 and automatically opens the circuit to allow charging of the internal battery 134.

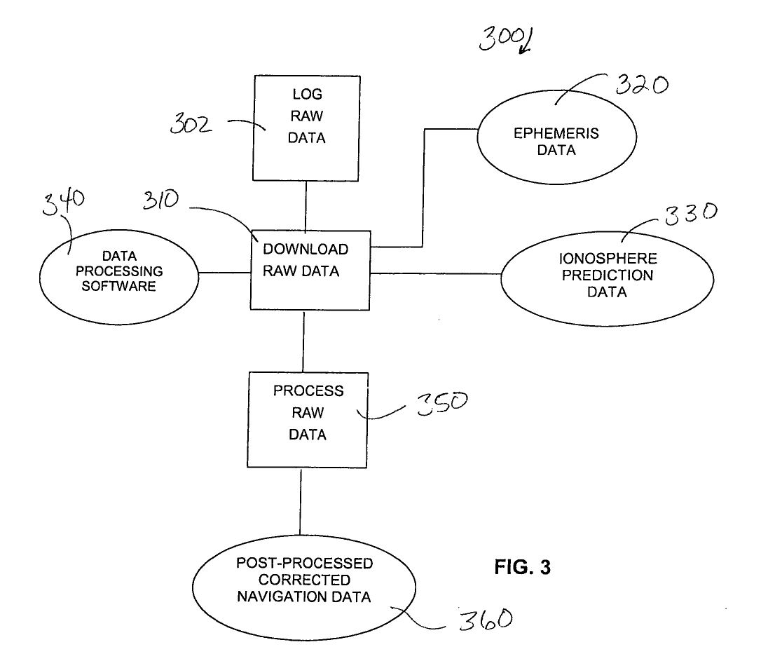

FIG. 3 illustrates a method 300 of using the GPS receiver/data logger 100 according to the invention to obtain corrected navigation data with an accuracy resolution of less than one meter (sub-meter accuracy). Raw data broadcast from GPS satellites is logged in the GPS receiver/data logger 100 (Step 302). At the end of the day or the logging session, the raw data is downloaded from the GPS receiver/data logger 100 to post-processing software 340 on a computing device by means of the external-device interface 150 (Step 310). In the preferred embodiment, the external-device interface 150 is a Bluetooth wireless interface and the post-processing software is the GPS PostPro™, Version 2.0 software by DeLorme Publishing Co. Ephemeris data 320 for the particular day and/or time of logging are downloaded from the Internet into the post-processing software, as are ionosphere prediction data 330. Examples of ephemeris tables and ionosphere prediction tables that provide the desired accuracy are available from the International GPS Service (IGS) or the Jet Propulsion Lab of NASA, and from the Center for Orbit Determination in Europe (CODE), respectively. The ephemeris data 320 and the ionosphere prediction data 330 are used to calculate the error correction for the raw data (Step 350). The post-processed corrected navigation data thus obtained (Step 360) is highly accurate and, depending on the selected accuracy of the ephemeris tables and ionosphere prediction tables, may be in the sub-meter range. The post-processed corrected navigation data may now be processed by proprietary road atlas or other mapping software, such as DeLorme Street Atlas® or mapping software, in order to view and/or map the corrected navigation data.

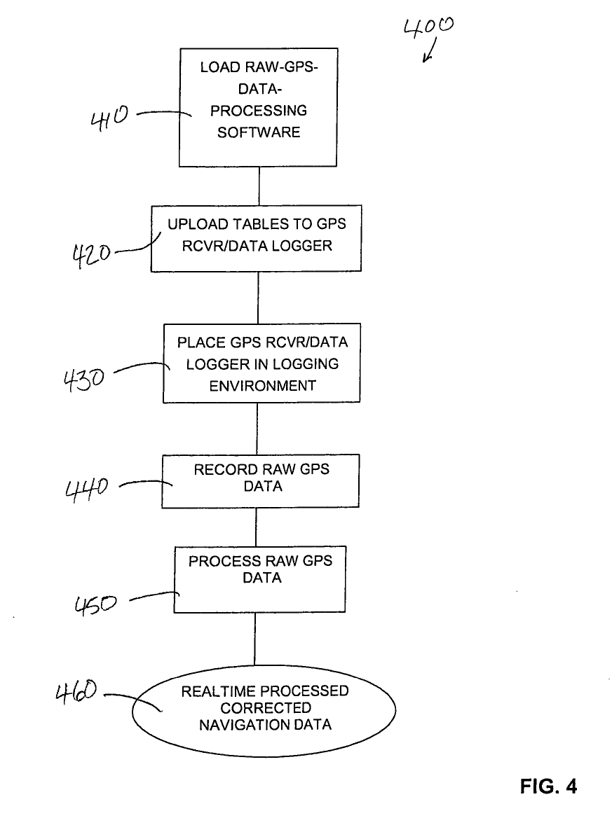

FIG. 4 illustrates a method 400 of real-time processing of raw GPS data to obtain corrected navigation data with the GPS receiver/data logger 100. Initially, the software for processing the raw GPS data is uploaded to the GPS receiver/data logger 100 and stored in the flash memory 126 (Step 410). These instructions include any filters for switching the GPS receiver/data logger 100 on or off. This uploading of the processing software is done when the GPS receiver/data logger 100 is initialized and repeated whenever the logging instructions are modified or replaced. At the beginning of the workday or logging session, the more accurate ephemeris tables and ionosphere prediction tables provided on the Internet are uploaded to the flash memory 126 (Step 420). Next, the GPS receiver/data logger 100 is placed in the logging environment (Step 430). This may be at a stationary location, or in a vehicle, etc. The GPS receiver/data logger 100 logs raw GPS data, either for a preset period of time or for the entire time, or according to the instructions stored in the flash memory 126 (Step 440). The processing software processes the raw GPS data as it is recorded into memory (Step 450). The real-time corrected navigation data is then downloaded to other application software, to obtain mapping or atlas information (Step 460).

The embodiments of the invention mentioned herein are merely illustrative of the present invention. It should be understood that a person skilled in the art of logging GPS data may contemplate many variations in construction of the present invention in view of the following claims without straying from the intended scope and field of the invention herein disclosed.

1. A GPS receiver/data logger comprising:
a GPS baseband radio frequency chip;
a GPS antenna, a data storage component, external-device interface, and a power circuit, all enclosed within a housing; and
data-processing software that is stored in said data storage component, said data-processing software being used for data retrieval and/or processing.

2. The GPS receiver/data logger of claim 1, further comprising an ON/OFF switch, mounted on an outside surface of said housing, wherein said ON/OFF switch is software-setable by a user so as initiate a data-recording function for a specified duration, after which duration said data-recording function is switched off

3. The GPS receiver/data logger of claim 2, further comprising an ON/OFF indicator LED that is illuminated when said data-recording function is switched on and not illuminated when said data-recording function is switched off.

4. A method for processing raw GPS data, said method comprising the steps of:
(a) obtaining accurate ephemeris data, wherein said accurate ephemeris data is accurate for a particular period;
(b) logging raw GPS data in said particular period in a GPS receiver/data logger;
(c) processing said raw GPS data with said accurate ephemeris data.

5. The method of claim 4, wherein said step (c) includes the steps of
(c1) downloading said raw GPS data into a computing device on which is stored data-processing software for processing said raw GPS data;
(c2) incorporating said accurate ephemeris data into said data-processing software; and
(c3) processing said raw GPS data with said accurate ephemeris data to obtain post-processed corrected navigation data.

6. The method of claim 4, wherein said step (c) includes the steps of:
(c4) uploading said accurate ephemeris data to said GPS receiver/data logger;
(c5) uploading raw-GPS-data processing software to said GPS receiver/data logger;
(c6) processing said raw GPS data with said accurate ephemeris data as said raw GPS data is recorded into said GPS receiver/data logger, to obtain corrected navigation data in real-time.

7. A method for processing raw GPS data, said method comprising the steps of:
(a) obtaining ionosphere predicion data, wherein said ionosphere prediction data is accurate for a particular period;
(b) logging raw GPS data in said particular period in a GPS receiver/data logger;
(c) processing said raw GPS data with said ionosphere prediction data.

8. The method of claim 7, wherein said step (c) includes the steps of
(c7) downloading said raw GPS data into a computing device on which is stored data-processing software for processing said raw GPS data;
(c8) incorporating said ionosphere prediction data into said data-processing software; and
(c9) processing said raw GPS data with said ionosphere prediction data to obtain post-processed corrected navigation data.

9. The method of claim 7, wherein said step (c) includes the steps of:
(c10) uploading said ionosphere prediction data to said GPS receiver/data logger;
(c11) uploading raw-GPS-data-processing software to said GPS receiver/data logger;
(c12) processing said raw GPS data with said ionosphere prediction data as said raw GPS data is recorded into said GPS receiver/data logger, to obtain corrected navigation data in real-time.
